(19) United States
(12) Patent Application Publication
(10) Pub. No.: US 2025/0265172 A1
(43) Pub. Date: Aug. 21, 2025

(54) AUTOMATED EVALUATION OF A TARGET SOFTWARE ARCHITECTURE FOR COMPLIANCE WITH SAFETY REQUIREMENTS

(71) Applicant: RED HAT, INC., Raleigh, NC (US)

(72) Inventor: Gabriele Paoloni, Lucca (IT)

(21) Appl. No.: 18/442,315

(22) Filed: Feb. 15, 2024

(51) Int. Cl. G06F 11/36

(52) U.S. Cl. CPC G06F 11/3604; G06F 11/3624

(57) ABSTRACT

A target software architecture can be automatically evaluated for compliance with safety requirements. For example, a system can receive safety requirement data indicating an allocation of safety requirements to an external input interface of a target software architecture. The system can determine at least one failure mode associated with the external input interface. The system can determine adjusted compile-time parameters and adjusted runtime parameters based on the at least one failure mode. The system can determine at least one architectural mitigation based on the at least one failure mode, the at least one architectural mitigation being configured to reduce an effect of the at least one failure mode. The system can then apply the at least one architectural mitigation to the external input interface.

### TECHNICAL FIELD

The present disclosure relates generally to computerized evaluation of software architectures. More specifically, but not by way of limitation, this disclosure relates to the automated evaluation of a target software architecture for compliance with one or more safety requirements.

### BACKGROUND

Many organizations around the globe have developed quality and safety standards for software. One example of such as standard is the ISO/IEC 2500 series of standards, defined by the International Organization for Standardization® (ISO). The ISO/IEC 2500 series of standards are also known as SQuaRE (System and Software Quality Requirements and Evaluation) and contain a framework to evaluate software quality characteristics such as functionality, usability, efficiency, security, reliability, portability, and maintainability. Another example of a standard is ISO 26262, which is an international safety standard for functional safety of electronic systems that are installed in road vehicles. The standard aims to address possible hazards caused by the malfunctioning electronic systems in vehicles. The standard can be used to qualitatively assess the risk of hazardous operational situations to avoid or mitigate systematic failures and to detect or mitigate random hardware failures. These standards often define functional and safety goals that must be complied with to receive certain certifications or approvals.

### BRIEF DESCRIPTION OF THE DRAWINGS

FIG. 1 shows a block diagram of an example of a system that includes a target software architecture according to some aspects of the present disclosure.

FIGS. 2A-E show flowcharts of an example of a process for automatically evaluating and mitigating problems related to a target software architecture according to some aspects of the present disclosure.

FIG. 3 shows a block diagram of an example of a system usable to implement the process of FIGS. 2A-E according to some aspects of the present disclosure.

FIG. 4 shows a flowchart of an example of a process for automatically evaluating and mitigating problems related to a target software architecture according to some aspects of the present disclosure.

### DETAILED DESCRIPTION

Organizations may want or need to comply with safety requirements (e.g., issued by a standard-setting organization) when developing a complex software architecture for end users. To determine whether a complex software architecture complies with safety requirements, a human evaluators may manually evaluate a design document for the complex software architecture against the safety requirements. The design document is an overall design document that can specify all of the architectural details and configurable parameters for the complex software architecture as a whole. The design document normally describes both static and dynamic aspects of the target architecture. But in many situations, there may be no such design document, which can make it challenging or impossible for the human evaluators to conduct their analysis. Additionally, this analysis can be time consuming and error prone.

Some examples of the present disclosure can overcome one or more of the abovementioned problems by providing an automated evaluation system that can evaluate complex software architecture against safety requirements, even in the absence of a design document for the complex software architecture. As one example, the automated evaluation system can receive safety requirement data indicating an allocation of safety requirements to an external input interface of a target software architecture. The automated evaluation system can determine at least one failure mode associated with the external input interface. The automated evaluation system can then determine adjusted compile-time parameters and adjusted runtime parameters based on the at least one failure mode. The automated evaluation system can further determine at least one architectural mitigation based on the at least one failure mode. The at least one architectural mitigation can be configured to reduce an effect of the at least one failure mode. The automated evaluation system can then apply the at least one architectural mitigation to the external input interface, to thereby automatically prevent the problem. In this way, the automated evaluation system can evaluate the complex software architecture against safety requirements, identify any potential problems before they arise, and mitigate those problems.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

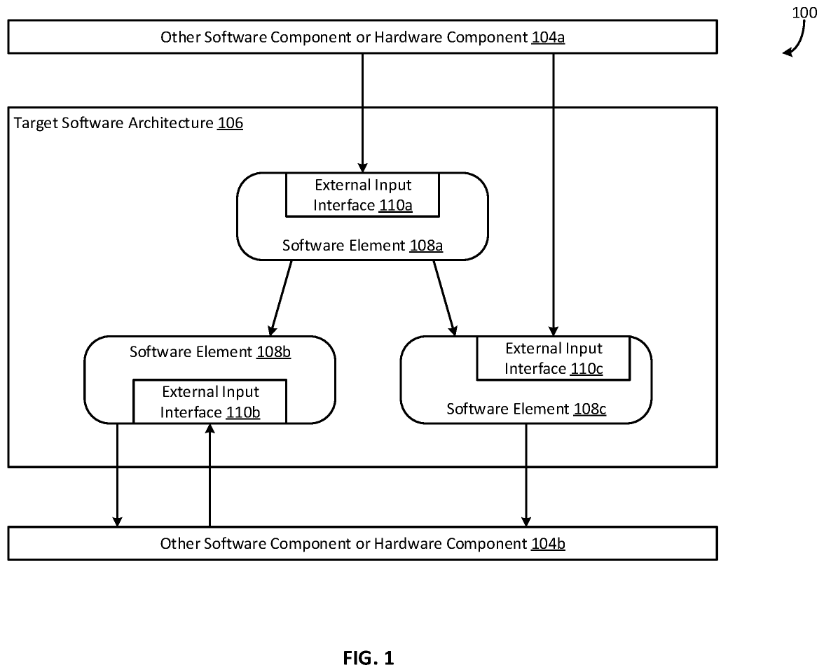

FIG. 1 shows a block diagram of an example of a system 100 that includes a target software architecture 106 according to some aspects of the present disclosure. The target software architecture 106 can include any number and arrangement of software elements, though three software elements 108a-c are shown in FIG. 1 for simplicity. Examples of the software elements 108a-c can include microservices, serverless functions, or any combination thereof. The software elements 108a-c can be standalone software programs that interact with one another via well-defined interfaces, such as application programming interfaces (APIs). These interfaces through which the software elements 108a-c communicate with one another, within the target software architecture 106, can be referred to as internal input interfaces. The software elements 108a-ccan also interact with other components 104a-b (e.g., software components or hardware components) outside the target software architecture 106. To do so, the software elements 108a-c may have external input interfaces 110a-c. The external input interfaces can also be via well-defined interfaces, such as APIs, through which the software elements can communicate with the components 104a-b outside the target software architecture 106. Examples of the external input interfaces 110a-c can include an exception handler, an interrupt handler, etc. The external input interfaces 110a-c can be different from the internal input interfaces. For example, the external input interfaces 110a-c may include functionality that is absent from or different from the internal input interfaces.

It may be challenging to evaluate the target software architecture 106 to ensure that it meets applicable safety requirements. This can be particularly true when there are a lot of complex interrelationships among the software elements, such as when a software element's functionality depends on the functionality of other software elements, referred to herein as “dependencies”. Additionally, many times the design documents necessary to conduct such an analysis are missing or incomplete, which can make it challenging to perform the analysis. Some examples of the present disclosure can help overcome these challenges by providing an automated or semi-automated process for evaluating complex software architectures against safety requirements, even in the absence of a design document.

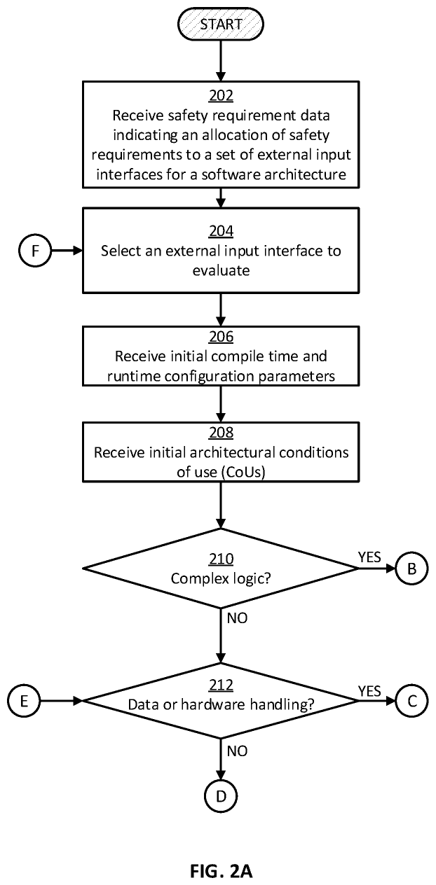

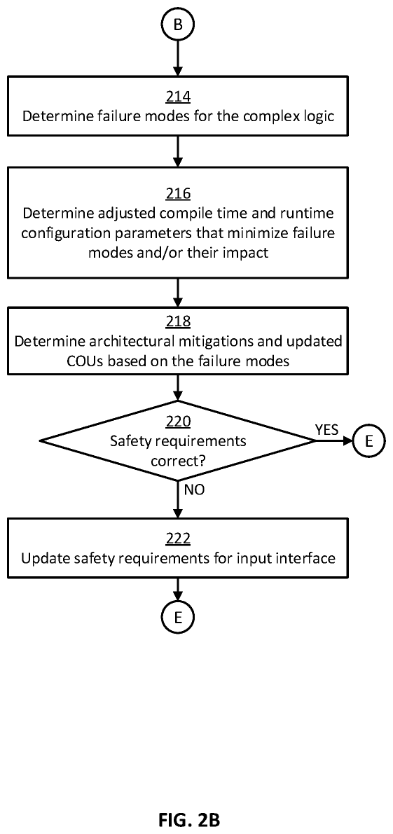

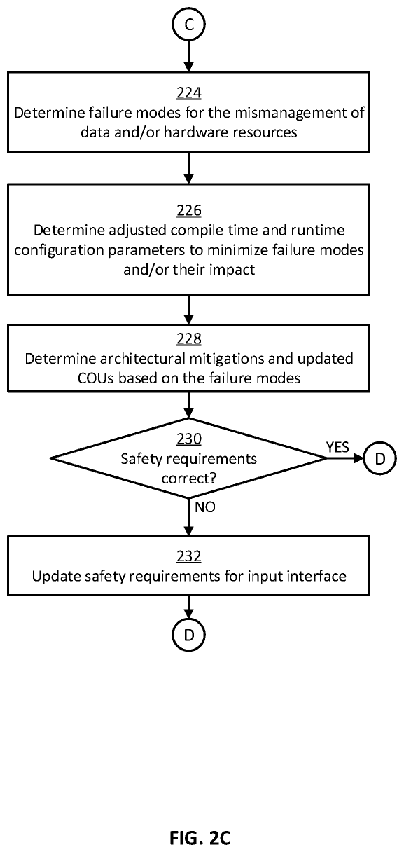

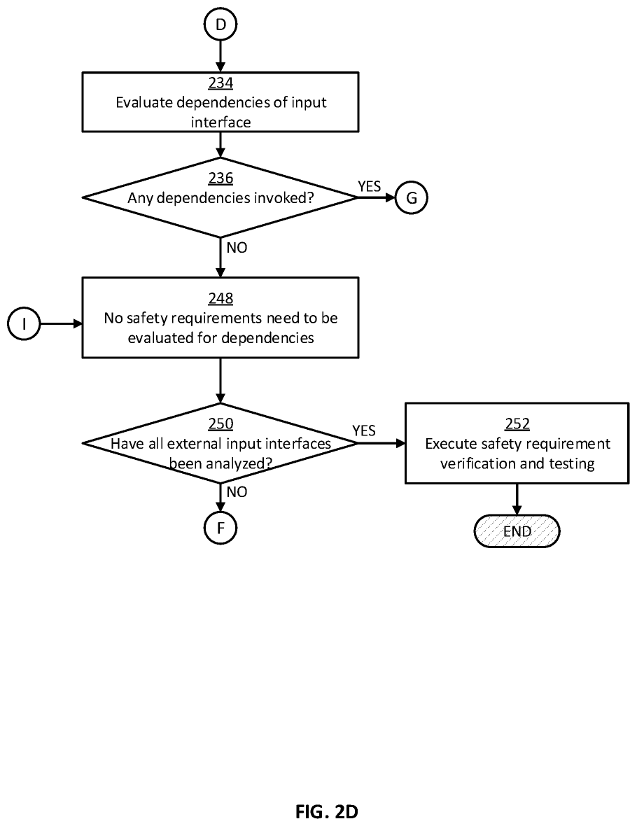

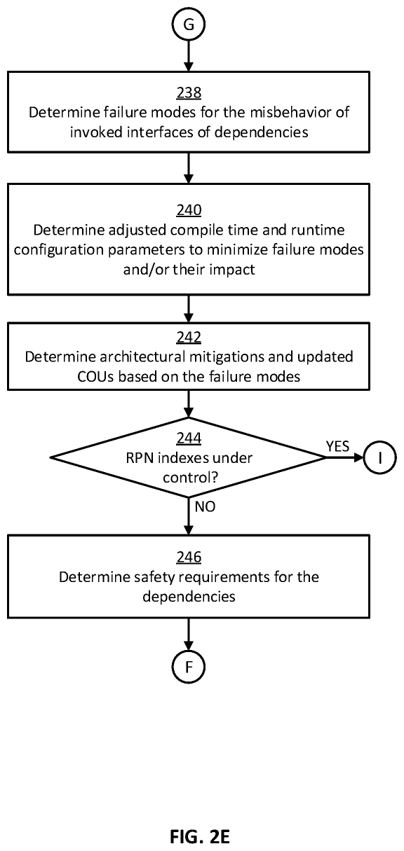

FIGS. 2A-E show an example of a process for evaluating a complex software architecture against safety requirements according to some aspects of the present disclosure. Other examples may include more steps, fewer steps, different steps, or a different order of steps than is shown in FIGS. 2A-E. The steps of FIGS. 2A-E are described below with reference to an automated evaluation system, which is shown and described in greater detail later on.

Starting with FIG. 2A, in block 202, the automated evaluation system receives safety requirement data. The safety requirement data can indicate an allocation (e.g., assignment) of safety requirements to a set of external input interfaces for a target software architecture, such as the external input interfaces 110a-c of the target software architecture 106 shown in FIG. 1. The safety requirements may be written in natural language form and defined by a customer or regulator. One or more safety requirements can be allocated to each individual external input interface. The safety requirement data can be stored in and received from a file, which may be written by an expert or developer associated with the external input interface.

In block 204, the automated evaluation system selects an external input interface referenced in the safety requirement data for evaluation. The automated evaluation system can select among the external input interfaces referenced in the safety requirement data for evaluation in any suitable order, such as in a sequential order or another order.

In block 206, the automated evaluation system receives an initial set of compile-time configuration parameters and runtime configuration parameters for the selected external input interface. The compile-time configuration parameters can include flags used in a compilation process for the software element that has the selected external input interface. Examples of the compile-time configuration parameters can include Kernal .config options as well as parameters defined in the script used to build the software element. The runtime configuration parameters can include settings that influence the runtime behavior of the software element that has the selected external input interface. Examples of the runtime configuration parameters can include hardware specific parameters read at runtime by the software elements, parameters passed as part of the boot command line, and parameters changed at runtime by sysfs or other available interfaces to tune the component behavior. The initial compile-time and run-time parameters can help drive the definition of expected behavior in the absence of failures. Different software elements may have different compile-time configuration parameters and runtime configuration parameters from one another. The compile-time configuration parameters and runtime configuration parameters can be stored in and received from a file, which may be written by an expert or developer associated with the software element or external input interface. This file may be the same as, or different from, the file described above with respect to block 202.

In block 208, the automated evaluation system receives an initial set of architectural conditions of use (COUs) associated with the external input interface. COUs can be constraints on the execution of the external input interface. One example of a COU can be that there is at least a predefined amount of memory space available in random access memory (RAM) to support the external input interface. Another example of a COU can be that an external watchdog shall be used to detect any failures associated with a delay or stop of the software element's functionalities. The COUs can help drive the definition of expected behavior in the absence of failures. The COUs can be stored in and received from a file, which may be written by an expert or developer associated with the software element or external input interface. This file may be the same as, or different from, any of the files described above.

At this stage, the automated evaluation system may have sufficient data required to begin evaluating the external input interface for compliance with the safety standards, even in the absence of a design document detailing the exact architecture of the target software architecture.

In block 210, the automated evaluation system determines whether the program code for the external input interface includes complex logic. An example of complex logic may include logic for pre-processing a received input parameter before invoking other components. More complex logic, such as logic that performs computations using the received input parameter, can have a higher chance of violating the safety requirements. Conversely, less complex logic, such as logic that simply wraps the input parameters, can have a lower chance of violating the safety requirements.

The automated evaluation system can determine whether the program code (e.g., source code) for the external input interface has at least a threshold level of complexity by analyzing the program code. For instance, the automated evaluation system can parse through the source code to identify certain features and functions therein, from which the complexity of the source code can be determined. If the automated evaluation system identifies, for example, multiple conditional statements and other indicators of complexity, the automated evaluation system can determine that the program code has at least the threshold level of complexity. If the automated evaluation system determines that the program code has at least the threshold level of complexity, the process can continue to block 214, shown in FIG. 2B. Otherwise, the process can continue to block 212.

Referring now to FIG. 2B, at block 214, the automated evaluation system determines failure modes for the complex logic. The automated evaluation system can determine the failure modes based at least in part on the initial set of compile-time configuration parameters and runtime configuration parameters for the selected external input interface. Failure modes can be conditions leading to the failure of the complex logic. The failure modes for the complex logic can be defined in and received from a file, which may be written by an expert or developer associated with the software element or external input interface. This file may be the same as, or different from, any of the files described above.

To determine which failure modes apply to the complex logic, the automated evaluation system can perform one or more tests on the complex logic. Such tests may involve, for example, injecting specially designed code stubs into the complex logic in an attempt to artificially trigger a failure. Additionally or alternatively, such tests may involve setting variables to invalid values in an attempt to artificially trigger a failure. For instance, the automated evaluation system can change one or more of the initial set of compile-time configuration parameters and runtime configuration parameters to invalid values in an attempt to trigger a failure. This testing process can help the automated evaluation system evaluate potential failures and their downstream effects.

Each failure mode can be defined by a group of fields. The group of fields can include a failure mode source, an expected behavior in the absence of a failure, a failure mode description and effect of failure, one or more safety requirements violated by the failure mode, RPN indexes (pre-and post-mitigations), and/or one or more recommended mitigation measures. The failure mode source can be the design element responsible for the failure mode. Examples of failure mode sources can be input parameters (e.g., if they are corrupted or out of boundaries), internal logic computation (e.g., if there is a wrong computation), software or hardware management or handling (e.g., mismanagement or wrong locking), external software interfaces (e.g., an outbound API is not behaving as expected), a software configuration (e.g., wrong configuration parameters or corrupted ones), a software calibration (e.g., wrong or corrupted calibration parameters).

In block 216, the automated evaluation system determines one or more adjusted compile-time configuration parameters and/or one or more adjusted runtime configuration parameters that would reduce (e.g., minimize) the failure modes and/or their impact. The adjusted parameters may be different from the initial parameters of block 206. In some examples, the automated evaluation system can prompt the user for the adjusted parameters. Additionally or alternatively, the automated evaluation system can derive the adjusted parameters from the failure mode definitions, such as the field that indicates recommended mitigation measures.

In block 218, the automated evaluation system determines one or more architectural mitigations and/or updated COUs based on the failure modes, where the architectural mitigations and/or updated COUs can be configured to reduce the effect of the failure modes. The architectural mitigations can be changes to the architecture of the target software architecture, such as changes to the number, arrangement, and/or dependencies of the software elements in the target software architecture. In some examples, the automated evaluation system can prompt the user for this information. Additionally or alternatively, the automated evaluation system can derive this information from the failure mode definitions, such as the field that indicates recommended mitigation measures.

In block 220, the automated evaluation system determines whether the safety requirements for the selected external input interface are correct. This may be achieved by comparing the safety requirements for the selected external input interface to safety requirements to similar types of external input interfaces, to determine whether there are any discrepancies. In some situations, a safety requirement may have accidentally been assigned to the selected external input interface that is inappropriate. Alternatively, the selected external input interface may be missing a safety requirement. Comparing the safety requirements assigned to the selected external input interface and similarity situated external input interfaces can help highlight these differences. In some examples, the automated evaluation system can automatically perform this comparison to identify any missing or extraneous safety requirements. Alternatively, the automated evaluation system can prompt a user to identify any missing or extraneous safety requirements for the selected external input interface.

If the safety requirements are correct, the process can continue to block 212 of FIG. 2A. Otherwise, the process can proceed to block 222, where the automated evaluation system can update the safety requirements for the external input interface. For example, the automated evaluation system can add a missing safety requirement to, or remove an extraneous safety requirement from, the list of safety requirements assigned to the selected external input interface.

Referring now to block 212 of FIG. 2A, the automated evaluation system determines whether the program code associated with the external input interface uses a particular type of data (e.g., static variables or global variables), or whether the external input interface interfaces with any hardware storing that particular type of data. This may be achieved by analyzing the source code associated with the external input interface. The automated evaluation system can analyze the source code by parsing the source code and identifying certain features, functions, and variable names. If the program code uses the particular type of data or interfaces with hardware storing that particular type of data, the process can continue to block 224 of FIG. 2C. Otherwise, the process can continue to block 234 of FIG. 2D.

Referring to block 224 of FIG. 2C, the automated evaluation system determines failure modes for the mismanagement of the data or hardware. The automated evaluation system can determine the failure modes based at least in part on the initial set of compile-time configuration parameters and runtime configuration parameters for the selected external input interface. As noted above, the failure modes can be conditions leading to failure of the external input interface, where in this instance the conditions are related to the mismanagement of the particular type of data or hardware. The failure modes can be defined in and received from a file, which may be written by an expert or developer associated with the software element or external input interface. This file may be the same as, or different from, any of the files described above. The automated evaluation system may determine which failure modes apply by performing testing, for example as described above with respect to block 214.

In block 226, the automated evaluation system determines one or more adjusted compile-time configuration parameters and/or one or more adjusted runtime configuration parameters that would reduce (e.g., minimize) the failure modes and/or their impact. The adjusted parameters may be different from the initial parameters of block 206. The automated evaluation system can determine the adjusted compile-time configuration parameters and/or one or more adjusted runtime configuration parameters using any of the techniques described above with respect to block 216.

In block 228, the automated evaluation system determines one or more architectural mitigations and/or updated COUs based on the failure modes, where the architectural mitigations and/or updated COUs can be configured to reduce the effect of the failure modes. The architectural mitigations can be changes to the architecture of the target software architecture, such as changes to the number, arrangement, and/or dependencies of the software elements in the target software architecture. The automated evaluation system can determine the architectural mitigations using any of the techniques described above with respect to block 218.

In block 230, the automated evaluation system determines whether the safety requirements for the selected external input interface are correct. This step can be performed using any of the techniques described above with respect to block 220. If the safety requirements are correct, the process can continue to block 234 of FIG. 2D. Otherwise, the process can proceed to block 232, where the automated evaluation system can update the safety requirements for the external input interface. This step can be performed using any of the techniques described above with respect to block 222.

Referring now to block 234 of FIG. 2D, the automated evaluation system evaluates the dependencies of the external input interface. The dependencies can be internal dependencies or external dependencies. An internal dependency can be a dependency on a feature or function of the target software architecture. An example of an internal dependency can be a dependency on an API of another software element of the target software architecture. An external dependency can be a dependency on a feature or function that is external to the software element. To determine the dependencies, the automated evaluation system can determine which other software elements are relied upon by the external input interface in performing its functionality. One way to make this determination can be to evaluate the source code for the external input interface. Another way to make this determination is to analyze a static architecture diagram, which can be a diagram indicating the symbols (e.g., functions and variables) relied upon by the software element, such as the Kernel symbols and library symbols relied upon by the software element. The automated evaluation system can automatically generate the static architecture diagram using a tool, such as Kernel Static-Analysis Navigator (ks-nav) or egypt, available at https://www.gson.org/egypt/egypt.html. Thus, the static architecture diagram is not an input to the process but rather is generated by the automated evaluation system as part of the process. Once generated, the static architecture diagram can be evaluated to determine the dependencies of the external input interface.

In block 236, the automated evaluation system determines whether any dependencies of the external input interface are invoked. For example, if the automated evaluation system did not identify any dependencies in block 234, then the automated evaluation system would determine that there are no dependencies of the external input interface invoked. If the automated evaluation system determines that the external input interface invokes one or more dependencies, the process can continue to block 238 of FIG. 2E. Otherwise, the process can continue at block 248.

Referring to block 238 of FIG. 2E, the automated evaluation system determines failure modes associated with the misbehavior of the invoked interfaces of the dependencies. The automated evaluation system can determine the failure modes based at least in part on the initial set of compile-time configuration parameters and runtime configuration parameters for the selected external input interface. As noted above, the failure modes can be conditions leading to failure of the external input interface, where in this instance the conditions are related to the misbehavior of invoked interfaces of the dependencies. The failure modes can be defined in and received from a file, which may be written by an expert or developer associated with the software element or external input interface. This file may be the same as, or different from, any of the files described above. The automated evaluation system may determine which failure modes apply by performing testing, for example as described above with respect to block 214.

In block 240, the automated evaluation system determines one or more adjusted compile-time configuration parameters and/or one or more adjusted runtime configuration parameters that would reduce (e.g., minimize) the failure modes and/or their impact. The adjusted parameters may be different from the initial parameters of block 206. The automated evaluation system can determine the adjusted compile-time configuration parameters and/or one or more adjusted runtime configuration parameters using any of the techniques described above with respect to block 216.

In block 242, the automated evaluation system determines one or more architectural mitigations and/or updated COUs based on the failure modes, where the architectural mitigations and/or updated COUs can be configured to reduce the effect of the failure modes. The architectural mitigations can be changes to the architecture of the target software architecture, such as changes to the number, arrangement, and/or dependencies of the software elements in the target software architecture. The automated evaluation system can determine the architectural mitigations using any of the techniques described above with respect to block 218.

In block 244, the automated evaluation system determines whether the Risk Priority Number (RPN) indexes for the external input interface meet or exceed a predefined threshold, which may be predefined by a safety engineer, organization, or other entity. If the RPN indexes are less than the predefined threshold, the process can proceed to block 246, where the automated evaluation system can determine the safety requirements for the dependencies (e.g., by retrieving the safety requirement data described above). The process can then return to block 204 of FIG. 2A and iterate for each dependency. On the other hand, if the RPN indexes meet or exceed the predefined threshold, the process can continue to block 248 of FIG. 2D.

In block 248 of FIG. 2D, the automated evaluation system determines that there are no safety requirements that are applicable for any dependencies. In other words, because there are no dependencies, then there are no safety requirements that need to be evaluated for dependencies.

In block 250, the automated evaluation system determines whether all external input interfaces have been analyzed. If so, the process can proceed to block 252. Otherwise, if there are more external input interfaces to analyze, the process can return to block 204 and iterate for the next external input interface.

At block 252, the automated evaluation system can perform safety requirement verification and testing, which can be the rest of the testing campaign to be performed on the software element to complete the functional safety qualification activities. Such testing may involve static code analysis, code review, etc.

In some examples, the safety requirement verification and testing can be performed based at least in part on a final set of architectural mitigations and/or COUs, which may have been produced as a result of blocks 218, 228, and/or 242. For instance, the initial set of COUs (received in block 208) may be first modified in block 218, to thereby produce a first set of modified COUs. The first set of modified COUs can be modified again in block 228, to thereby produce a second set of modified COUs. The second set of modified COUs can be modified yet again in block 242, to thereby produce a third set of modified COUs. This third set of modified COUs can serve as the final set of COUs, which can be used as the basis for the safety requirement verification and testing.

Additionally or alternatively, the safety requirement verification and testing can be performed based at least in part on a final set of compile-time configuration parameters and runtime configuration parameters, which may have been produced as a result of blocks 216, 226, and/or 240. For instance, the initial set of compile-time configuration parameters and runtime configuration parameters (received in block 206) may be first modified in block 216, to thereby produce a first set of modified compile-time configuration parameters and runtime configuration parameters. The first set of modified compile-time configuration parameters and runtime configuration parameters can be modified again in block 226, to thereby produce a second set of modified compile-time configuration parameters and runtime configuration parameters. The second set of modified compile-time configuration parameters and runtime configuration parameters can be modified yet again in block 240, to thereby produce a third set of modified compile-time configuration parameters and runtime configuration parameters. This third set of modified compile-time configuration parameters and runtime configuration parameters can serve as the final set of compile-time configuration parameters and runtime configuration parameters, which can be used as the basis for the safety requirement verification and testing.

Using this approach, the external input interfaces for the software elements of the target software architecture can be analyzed for problems such as non-compliance with safety requirements. If a problem is identified, it can be mitigated through the automated selection and adjustment of compile time parameters, runtime parameters, and/or architectural parameters, which can improve the functionality of the target software architecture.

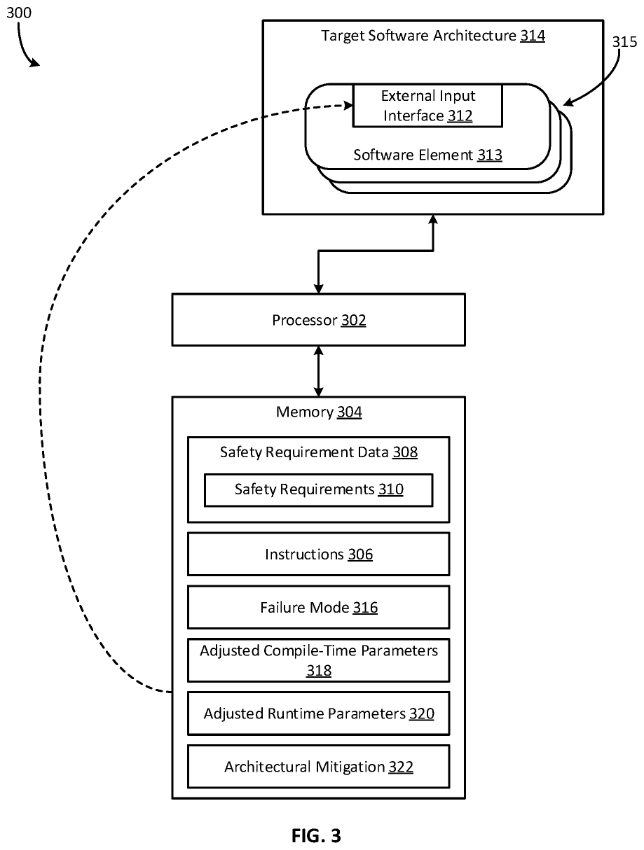

FIG. 3 shows a block diagram of an example of a system 300 for implementing the process of FIGS. 2A-E according to some aspects of the present disclosure. The system 300 includes a processing device 302 coupled to memory 304. The processing device 302 is hardware that can include one processor or multiple processors. The processing device 302 can execute instructions 306 stored in the memory 304 to perform one or more operations. In some examples, the instructions 306 can include processor-specific instructions generated by a compiler or an interpreter from code written in any suitable computer-programming language, such as C, C++, C#, and Java. In some examples, the instructions 306 can correspond to the automated evaluation system described above.

The memory 304 can include one memory device or multiple memory devices. The memory 304 can be volatile or non-volatile (i.e., the memory 304 can retain stored information when powered off). Examples of the memory 304 include electrically erasable and programmable read-only memory (EEPROM), flash memory, or any other type of non-volatile memory. At least a portion of the memory device includes a non-transitory computer-readable medium. A computer-readable medium can include electronic, optical, magnetic, or other storage devices capable of providing the processing device 302 with the instructions 306 or other program code. Examples of a computer-readable medium include magnetic disks, memory chips, ROM, RAM, an ASIC, a configured processor, optical storage, or any other medium from which a computer processor can read the instructions 306.

The processing device 302 can execute the instructions 306 to perform operations. For example, the processing device 302 can receive safety requirement data 308 indicating an allocation of safety requirements 310 to an external input interface 312 of a software element 313 of a target software architecture 314. The target software architecture 314 can include a plurality of standalone software elements 315 configured to interact with one another. The processing device 302 can determine at least one failure mode 316 associated with the external input interface 312. The processing device 302 can determine adjusted compile-time parameters 318, adjusted runtime parameters 320, or both based on the at least one failure mode 316. The processing device 302 can determine at least one architectural mitigation 322 based on the at least one failure mode 316. The at least one architectural mitigation 322 can be configured to reduce an effect of the at least one failure mode 316. The processing device 302 can then apply the at least one architectural mitigation 322 to the external input interface 312, as represented by the dashed line in FIG. 3, which can help avoid the failure or reduce the effect of the failure.

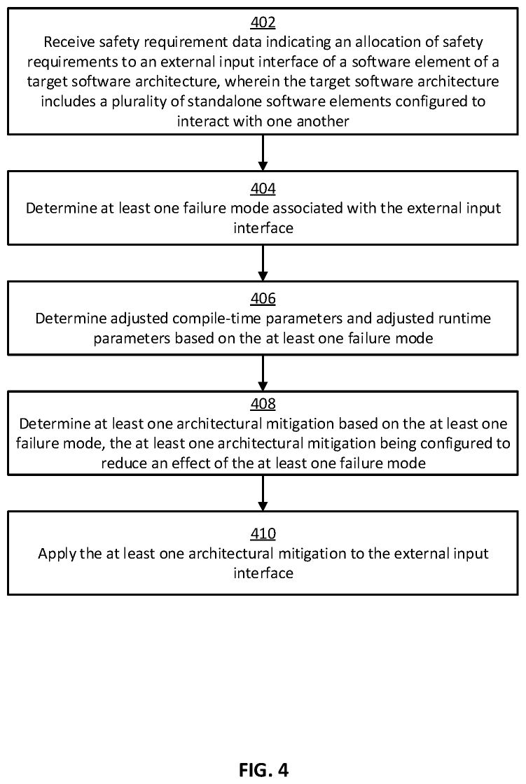

FIG. 4 shows a flowchart of an example of a process for automatically evaluating and mitigating problems related to a target software architecture according to some aspects of the present disclosure. Other examples may involve more operations, fewer operations, different operations, or a different sequence of operations than is shown in FIG. 4. The operations of FIG. 4 are described below with reference to the components of FIG. 3 described above.

In block 402, the processing device 302 receives safety requirement data 308 indicating an allocation of safety requirements 310 to an external input interface 312 of a software element 313 of a target software architecture 314. The target software architecture 314 can include a plurality of standalone software elements 315 configured to interact with one another. The processing device 302 can receive the safety requirement data as user input or from a predefined file.

In block 404, the processing device 302 determines at least one failure mode 316 associated with the external input interface 312. In some examples, the at least one failure mode can include multiple failure modes. For example, the at least one failure mode includes a first failure mode associated with a complexity of logic in the external input interface, a second failure mode associated with mismanagement of data or hardware resources, and/or a third failure mode associated with misbehavior of invoked interfaces of dependencies of the external input interface.

In block 406, the processing device 302 determines adjusted compile-time parameters 318 and/or adjusted runtime parameters 320 based on the at least one failure mode 316. The adjusted parameters are adjusted from an initial set of parameters that can be received prior to this step.

In block 408, the processing device 302 determines at least one architectural mitigation 322 based on the at least one failure mode 316. In some examples, the at least one architectural mitigation 322 can include multiple architectural mitigations. For instance, the at least one architectural mitigation 322 can include a first architectural mitigation configured to resolve a problem in the complexity of the logic in the external input interface, a second architectural mitigation configured to resolve the mismanagement of the data or the hardware resources, and/or a third architectural mitigation configured to resolve the misbehavior of the invoked interfaces of the dependencies of the external input interface. The at least one architectural mitigation 322 can be configured to reduce an effect of the at least one failure mode 316. The processing device 302 can determine the at least one architectural mitigation 322 based on recommended mitigation data stored in definitions of the failure modes. A definition associated with each respective failure mode can include one or more corresponding recommended mitigations.

In block 410, the processing device 302 applies the at least one architectural mitigation 322 to the external input interface 312. This can help avoid the failure or reduce the effect of the failure. Applying the at least one architectural mitigation 322 to the external input interface 312 can involve modifying the source code of the external input interface 312, modifying a parameter of the external input interface 312, or both of these, to implement the at least one architectural mitigation 322.

The above description of certain examples, including illustrated examples, has been presented only for the purpose of illustration and description and is not intended to be exhaustive or to limit the disclosure to the precise forms disclosed. Modifications, adaptations, and uses thereof will be apparent to those skilled in the art without departing from the scope of the disclosure. For instance, any examples described herein can be combined with any other examples.

1. A non-transitory computer-readable medium comprising program code that is executable by one or more processors for causing the one or more processors to perform operations including:
receiving safety requirement data indicating an allocation of safety requirements to an external input interface of a software element of a target software architecture, wherein the target software architecture includes a plurality of standalone software elements configured to interact with one another;
determining at least one failure mode associated with the external input interface;
determining adjusted compile-time parameters and adjusted runtime parameters based on the at least one failure mode;
determining at least one architectural mitigation based on the at least one failure mode, the at least one architectural mitigation being configured to reduce an effect of the at least one failure mode; and
applying the at least one architectural mitigation to the external input interface.

2. The non-transitory computer-readable medium of claim 1, wherein the at least one failure mode includes a first failure mode associated with a complexity of logic in the external input interface, a second failure mode associated with mismanagement of data or hardware resources, and a third failure mode associated with misbehavior of invoked interfaces of dependencies of the external input interface.

3. The non-transitory computer-readable medium of claim 2, wherein the at least one architectural mitigation includes a first architectural mitigation configured to resolve a problem in the complexity of the logic in the external input interface, a second architectural mitigation configured to resolve the mismanagement of the data or the hardware resources, and a third architectural mitigation configured to resolve the misbehavior of the invoked interfaces of the dependencies of the external input interface.

4. The non-transitory computer-readable medium of claim 1, wherein the operations further comprise:
determining whether the safety requirements are correct; and
updating the safety requirements in response to determining that there is a missing or extraneous safety requirement.

5. The non-transitory computer-readable medium of claim 1, wherein the operations further comprise:
determining a dependency of the external input interface;
evaluating the dependency for a corresponding failure mode; and
in response to detecting one or more failure modes associated with the dependency, determining the adjusted compile-time parameters and adjusted runtime parameters based on the one or more failure modes associated with the dependency.

6. The non-transitory computer-readable medium of claim 1, wherein the operations further comprise:
determining a dependency of the external input interface;
evaluating the dependency for a corresponding failure mode; and
in response to detecting one or more failure modes associated with the dependency, determining the at least one architectural mitigation based on the one or more failure modes associated with the dependency.

7. The non-transitory computer-readable medium of claim 1, wherein the operations further comprise recursively evaluating dependencies of the external input interface for failure modes and modifying the at least one architectural mitigation based on the failure modes.

8. A method comprising:
receiving safety requirement data indicating an allocation of safety requirements to an external input interface of a software element of a target software architecture;
determining at least one failure mode associated with the external input interface;
determining adjusted compile-time parameters and adjusted runtime parameters based on the at least one failure mode;
determining at least one architectural mitigation based on the at least one failure mode, the at least one architectural mitigation being configured to reduce an effect of the at least one failure mode; and
applying the at least one architectural mitigation to the external input interface.

9. The method of claim 8, wherein the at least one failure mode includes a first failure mode associated with a complexity of logic in the external input interface, and a second failure mode associated with misbehavior of invoked interfaces of dependencies of the external input interface.

10. The method of claim 9, wherein the at least one architectural mitigation includes a first architectural mitigation configured to resolve a problem in the complexity of the logic in the external input interface, a second architectural mitigation configured to resolve the misbehavior of the invoked interfaces of the dependencies of the external input interface. 11 The method of claim 8, further comprising:
determining whether the safety requirements are correct; and
updating the safety requirements in response to determining that there is a missing or extraneous safety requirement.

12. The method of claim 8, further comprising:
determining a dependency of the external input interface;
evaluating the dependency for a corresponding failure mode; and
in response to detecting one or more failure modes associated with the dependency, determining the adjusted compile-time parameters and adjusted runtime parameters based on the one or more failure modes associated with the dependency.

13. The method of claim 8, further comprising:
determining a dependency of the external input interface;
evaluating the dependency for a corresponding failure mode; and
in response to detecting one or more failure modes associated with the dependency, determining the at least one architectural mitigation based on the one or more failure modes associated with the dependency.

14. The method of claim 8, further comprising recursively evaluating dependencies of the external input interface for failure modes and modifying the at least one architectural mitigation based on the failure modes.

15. A system comprising:
one or more processors; and
a non-transitory computer-readable medium comprising program code that is executable by the one or more processors for causing the one or more processors to perform operations including:
receiving safety requirement data indicating an allocation of safety requirements to an external input interface of a software element of a target software architecture, wherein the target software architecture includes a plurality of standalone software elements configured to interact with one another;
determining at least one failure mode associated with the external input interface;
determining adjusted compile-time parameters and adjusted runtime parameters based on the at least one failure mode;
determining at least one architectural mitigation based on the at least one failure mode, the at least one architectural mitigation being configured to reduce an effect of the at least one failure mode; and
applying the at least one architectural mitigation to the external input interface.

16. The system of claim 15, wherein the at least one failure mode includes a first failure mode associated with a complexity of logic in the external input interface and a second failure mode associated with mismanagement of data or hardware resources.

17. The system of claim 16, wherein the at least one architectural mitigation includes a first architectural mitigation configured to resolve a problem in the complexity of the logic in the external input interface, and a second architectural mitigation configured to resolve the mismanagement of the data or the hardware resources.

18. The system of claim 15, wherein the operations further comprise:
determining whether the safety requirements are correct; and
updating the safety requirements in response to determining that there is a missing or extraneous safety requirement.

19. The system of claim 15, wherein the operations further comprise:
determining a dependency of the external input interface;
evaluating the dependency for a corresponding failure mode; and
in response to detecting one or more failure modes associated with the dependency:
determining the adjusted compile-time parameters and adjusted runtime parameters based on the one or more failure modes associated with the dependency; and
determining the at least one architectural mitigation based on the one or more failure modes associated with the dependency.

20. The system of claim 15, wherein the operations further comprise recursively evaluating dependencies of the external input interface for failure modes and modifying the at least one architectural mitigation based on the failure modes.
